(19) United States
(12) Patent Application Publication
(10) Pub. No.: US 2002/0124426 A1
(43) Pub. Date: Sep. 12, 2002

(54) Picture-hanging template

(76) Inventor: Kenneth Dewberry, Columbus, GA (US)

Correspondence Address: John W. Greenwald, GARDNER GROFF & MEHRMAN, P.C., Paper Mill Village, Building 23, 600 Village Trace, Suite 300, Marietta, GA, 30067, US

(21) Appl. No.: 10/059,050

(22) Filed: Jan. 28, 2002

Related U.S. Application Data
(60) Provisional application No. 60/264,366, filed on Jan. 26, 2001.

(51) Int. Cl. G01B 3/04

(52) U.S. Cl. 33/494; 33/41.4; 33/613

(57) ABSTRACT

A device that aids in the positioning of wall hangings, such as pictures, photos or paintings, on a wall at a consistent distance from other visual elements. The device is in the form of a rectangular template with a series of evenly spaced holes along the centerline of the long axis of the rectangle. The template provides a linear measurement scale. The distance of each hole from the upper edge of the rectangle is marked on the template body. The center of gravity of the template also lies along the centerline of the long axis of the rectangle.

### CROSS REFERENCE TO RELATED APPLICATION

The present non-provisional patent application claims priority of U.S. Provisional Application Serial Number 60/264,366, filed on Jan. 26, 2001.

### FIELD OF THE INVENTION

The invention relates generally to devices that aid in the hanging of objects on a wall or other surface and, more particularly, to a template to aid in the positioning of wall-mounted pictures.

### BACKGROUND OF THE INVENTION

As may be appreciated by anyone familiar with home or office decor, the optimal positioning of wall hangings, such as pictures, photos or paintings, on a wall can be a frustrating experience. Separate from the scene depicted in the work of art, photo, etc., the general shape of the picture and frame form a visual element when placed on the wall surface. The size, shape and positioning of the picture adds to the viewer's overall visual impression of the wall and room. Often it is desirable to position a picture on a wall at a visually appealing distance from another visual element of the wall. Such visual elements may be an architectural feature, such as a chair rail or crown molding, or may simply be another wall hanging already positioned on the wall.

It is often desirable to have a consistent spacing between wall hangings and other significant visual elements. Of visual interest is both the vertical spacing between elements and the horizontal offset between elements lying one above another on the same general wall surface. For example, when three pictures are positioned on a wall, one above another, it is visually desirable to have the elements spaced a consistent vertical distance apart. In the horizontal direction, it is also desirable to have the pictures either in alignment, with one directly below another, or spaced a consistent horizontal distance apart. Hence, three pictures of relatively the same size that are spaced a consistent distance above one another are typically more visually appealing than a random placement of the same art. The pictures may also be offset a uniform horizontal distance from one another to create a visually appealing stair-step effect.

Wall hangings are typically mounted on a wall by an installer with a preconceived notion of location and spacing to other visual elements. The installer then typically steps back to a reasonable viewing distance to get an overall visual impression, or he may hold the art in place while another viewer provides an opinion regarding the placement. Hence, the “how does that look” scenario may be repeated many times. The result typically is an iterative process of attempting to achieve a visually appealing placement of the art. This iterative process sometimes results in multiple unnecessary nail holes being made in a wall to hang a single picture in the most visually appealing location.

The spacing of pictures is often accomplished by eye and may often look “about right,” but can still lack in spacing consistency with other elements on the same wall. A tape measure or other similar measuring device may be used to attempt to achieve a consistent spacing, but the tape measure must be held in place against the wall during any measurements and provides no vertical or horizontal reference. The installer must approach the wall and take a measurement from an existing visual element while estimating the vertical or horizontal direction on the wall surface. The installer then marks a location on the wall surface and steps back to a proper viewing distance to get the visual impression the art might create in that position. Hence, the installer is still faced with an imprecise and frustrating iterative process.

A combination of vertical and horizontal spacing between multiple pictures on the same wall presents special challenges. It is often desirable to position multiple pictures one above another, or to position multiple pictures in a stair-step pattern leading down and across a wall. Of special difficulty is ensuring that the pictures are in alignment horizontally, or that the pictures are spaced a consistent horizontal distance apart. For example, if the installer is attempting to achieve a stair-step placement of the art, the installer must measure both vertically down and horizontally across the wall from an existing visual element. In doing so, the installer must estimate the true vertical direction (down the wall), take a measurement and mark a location. Then, restarting from the marked location, the installer must estimate the true horizontal direction (across the wall), take a measurement and mark the final picture location. Any error the installer makes in estimating the vertical and horizontal directions will directly and adversely affect the final placement of the art.

Adding to the difficulty, the installer must accomplish these tasks while standing directly adjacent to the wall. The close proximity of the wall substantially denies the installer the typical horizontal and vertical visual references, i.e., the floor or ceiling and adjacent side walls, that are available to a more remote viewer. Unfortunately, it is the remote viewer who will evaluate the result of the installer's efforts.

Therefore, it can be seen there is a need for a device that aids in the positioning of pictures, art, and/or other wall hangings on a wall at a consistent spacing from other visual elements. There is also a need for a device that provides a vertical and horizontal spacing reference and a linear distance measurement for the installer. There is a further need for a device that may be affixed in position on the wall surface and that may then be viewed from a distance by the installer in order to evaluate the visual impression that will be created by a selected spacing and placement of the wall hanging. It is to the provision of a device meeting these and other needs that the present invention is primarily directed.

### SUMMARY OF THE INVENTION

Briefly described, in a preferred form the present invention comprises a device that aids in the positioning of wall hangings (such as pictures) on a wall at a consistent distance from other visual elements. More specifically, the present invention preferably provides a means for measuring the vertical distance from a selected point on a wall and provides a vertical reference line to that point. In the horizontal spacing of visual elements, the invention preferably provides a self-aligning vertical reference line to the location of the previous element from which a horizontal measurement may be taken to aid the positioning of adjacent elements. The invention also preferably provides a measuring means that is self-supporting on the wall surface and presents a measurement scale that may be easily read from a distance by the installer.

Stated another way, the present invention comprises a template to aid the hanging of pictures and the like. The template preferably comprises a generally rectangular plate, sheet, or other body with apertures spaced at intervals along the longitudinal axis of the template. The center of gravity of the template preferably lies along the longitudinal axis on which the apertures are placed. Preferably, the distance of each aperture from the upper edge of the template is clearly labeled on the surface of the template.

In use, the template is preferably positioned on a wall with the upper edge of the template abutting a visual element of interest. The rectangular nature of the template aids in the determination of perpendicular distances from existing visual elements or boundaries such as a ceiling, floor, or adjacent wall. The installer may then use the template to determine the proper spacing and mark appropriate distances for the positioning of adjacent visual elements. The installer preferably then marks the locations of interest directly through the appropriate apertures within the template, as with a pencil, pen or marker.

Alternatively, the installer can support the template on the wall using a nail placed through the uppermost aperture. The template will then hang in a true vertical orientation due to the center of gravity of the template lying along the longitudinal axis of the template body. The installer can then view the template from a distance to ascertain appropriate spacing from the point of support and other adjacent visual elements. A location of interest preferably is then marked through the appropriate aperture within the template. The installer can also take horizontal measurements using the hanging template as a true vertical reference to the point of support.

In another aspect, a preferred form of the present invention comprises a template to aid in the hanging of pictures and the like. The template is preferably substantially longer than it is wide and has a central longitudinal axis. A series of apertures are preferably formed through the template and are generally spaced at intervals in a line along the longitudinal axis.

Preferably, the template is in the shape of a substantially rectangular plate. The template preferably includes visible indicia associated with each aperture. The template body is preferably substantially transparent. The center of gravity of the template preferably lies along the template's longitudinal axis, on which the apertures are spaced. Any of the aforementioned preferred optional embodiments can be used singularly with the preferred form, or in any combination therewith.

These and other features and advantages of the present invention will become apparent from the following detailed description of the preferred embodiment and from the appended drawings and claims.

### BRIEF DESCRIPTION OF THE DRAWINGS

FIG. 1 is a front view of a picture-hanging template according to a preferred form of the present invention.

FIG. 2 is a front view of the template of FIG. 1 in use.

FIG. 3 is a second illustration of the template of FIG. 1 in use.

FIG. 4 is a front view of a first alternative template with three series of holes.

FIG. 5 is a front view of a second alternative template with the holes provided by one slot.

FIG. 6 is a front view of a third alternative template with enlarged heads at the ends.

FIG. 7 is a front view of a fourth alternative template with a pivotal secondary member for aiding in horizontal spacing.

### DETAILED DESCRIPTION OF THE PREFERRED EMBODIMENT

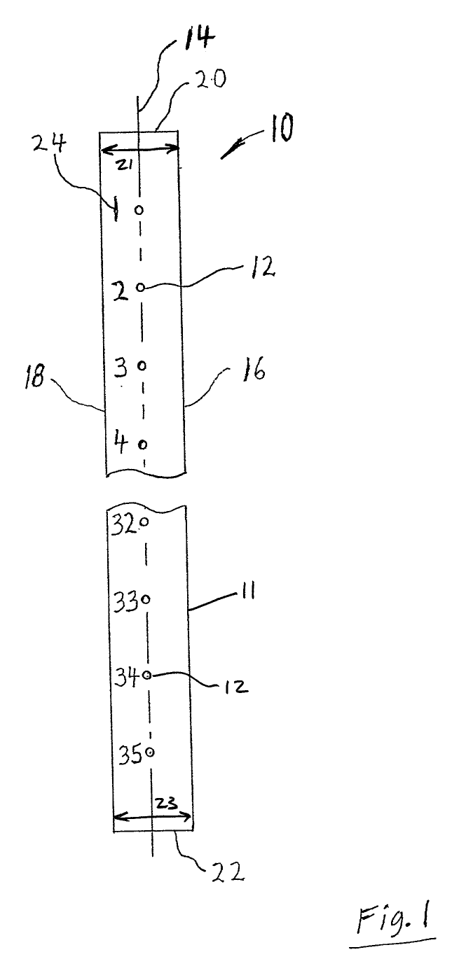

Referring now to the drawing figures, wherein like references numerals represent like parts throughout the several views, FIG. 1 shows an illustrative embodiment of a picture-hanging template of the present invention, represented generally by reference numeral 10. The template 10 comprises a body 11 such as a rectangular sheet of transparent plastic. The template body 11 can alternatively be constructed of another material, such as metal, acrylic, rubber, wood, a composite, or the like, and can be formed into a block or other regular or irregular shape. While the template 10 can be any desired length, a 36-inch length has been found to be very practical for many routine applications.

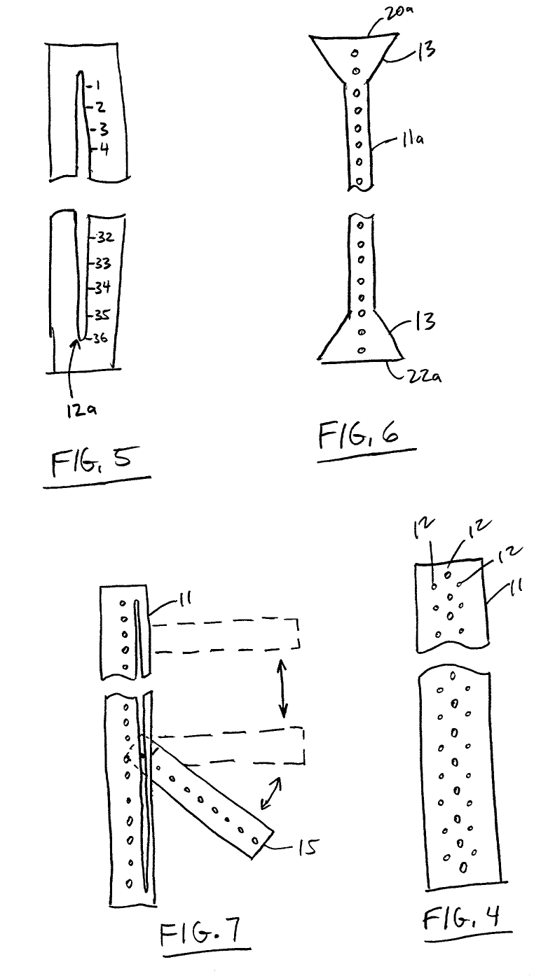

At least one series of holes 12 are provided with the holes of each series spaced apart from one another and formed through the template body 11, for example, along the template longitudinal axis 14. Alternatively, the holes 12 may be positioned off-center from the template longitudinal axis 14, or some of the holes may be along the axis and some off-center from it (see FIG. 4). The holes 12 may be uniformly spaced apart, for example, by one inch, one-half inch, one centimeter, by another unit of measurement, or by any other desired distance. Alternatively, some of the holes 12 may be spaced apart by one distance, such as by one inch, with other holes spaced apart by a smaller distance, such as by one-half inch. If desired, some of the holes 12 may be spaced apart from each other by a random distance. Also, it will be understood that when it is said herein that the template has a series of holes or apertures, this can mean one slot 12a along a substantial length of the template body 11 (see FIG. 5). That is, the series of holes may be in communication with each other and spaced so closely together that they form a single slot.

Furthermore, two, three, or another number of hole series' can be provided, with the holes of one series staggered relative to the holes of another series (see FIG. 4), with the holes of one series spaced apart by a distance in English units and the holes of another series spaced apart by a distance in metric units, or with the holes arranged otherwise. Also, the template body 11 can have a frusto-conical, cross-shaped, square, or other shape, with one or more series of vertical holes (for use as described below) and one or more series of horizontal holes for horizontally spacing the objects to be hung. Additionally or alternatively, some or all of the holes may be provided by notches formed in one or more sides of the template body 11.

Each hole 12 may be sized so that a pencil tip or small nail (of the type commonly used for hanging objects on walls) can pass through it. For example, holes 12 with an approximately 0.125-inch diameter have been found to be very practical for many routine applications. Also, the holes 12 may be round, slotted, rectangular, or star-shaped, or they may have another regular or irregular shape.

Each hole 12, or only some of them, may be clearly marked with indicia 24, for example, a numerical measurement in inches, centimeters, or another unit of measurement representing the linear distance of the particular hole from the template upper edge 20, measured along the longitudinal axis 14. Alternatively, the indicia 24 may be provided by letters or other markings, or they may be arranged with a zero in the middle and increasing numerals on each side of the zero. If it is desired to provide one long slot (or several shorter ones) along the length of the template body 11, then the indicia 24 may be positioned along the slot at regularly spaced positions corresponding to the linear distance just mentioned (see FIG. 5). The indicia 24 may be printed, stenciled, adhered, engraved, or otherwise marked on or in the template, as desired.

The template body 11 has sides 16 and 18 that are evenly spaced on either side of and parallel to the longitudinal axis 14. The upper and lower edges of the template body 11, edges 20 and 22 respectively, are formed perpendicular to longitudinal axis 14. The upper and lower edges 20 and 22 may have widths 21 and 23, respectively, that are sufficiently wide that, when abutted against a surface, permit the template longitudinal axis 14 define a direction perpendicular to the surface. In an alternative aspect of the invention, the template body 11a may have flared upper and/or lower ends so that the upper and/or lower edges 20a and 22a are wider than the template body 11a at its middle (see FIG. 6). In other words, the template body 11a may have an enlarged head 13 at one or both of its ends, the head having the shape of a triangle, semi-circle, etc. with a flat surface defining the edge 20a or 22a.

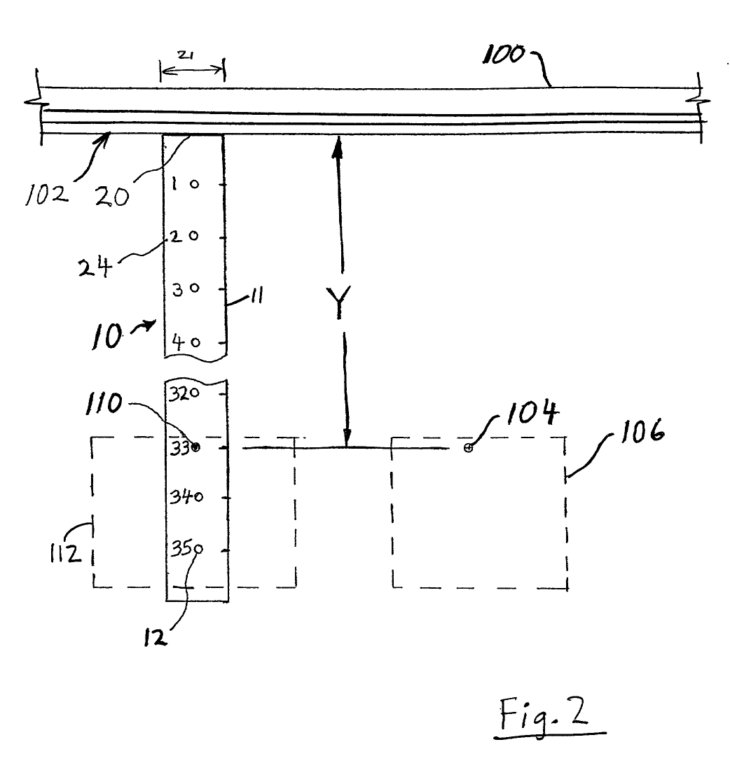

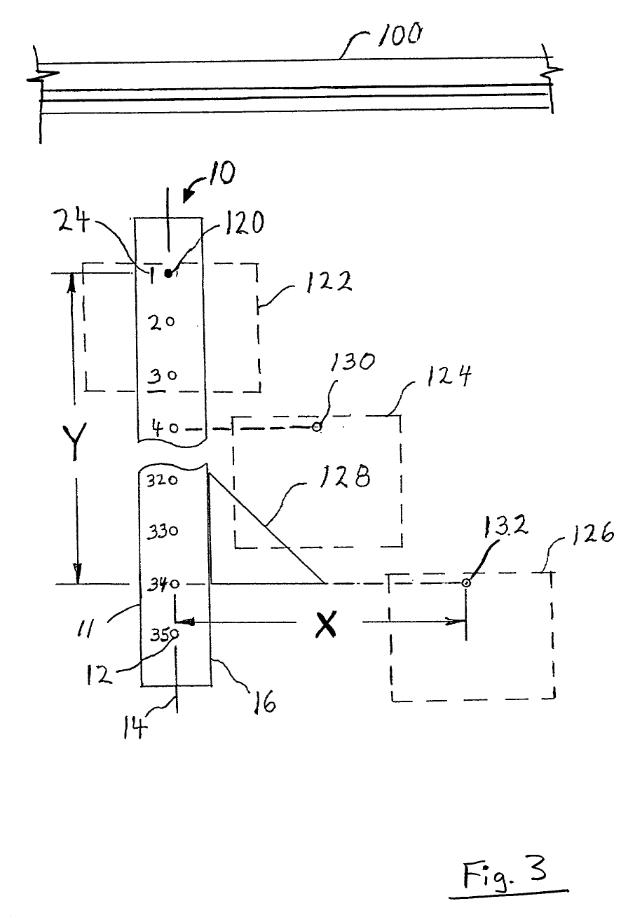

In use, as shown in FIGS. 2 and 3, the template 10 is placed on a wall surface and provides a vertical reference and a vertical measuring means. The template provides a vertical reference by abutting against a pre-existing horizontal surface 102 such as a crown molding or a chair rail, as shown in FIG. 2. Or as shown in FIG. 3, the template 10 can assume a vertical orientation due to the force of gravity acting on the template body. In this way, the feature of the holes 12 being positioned along the template longitudinal axis 14 coincident with the center of gravity is very advantageous. In particular, the vertical measuring means is provided by the numerical measurements 24 marked on the template body 11, which is now in a vertical position.

FIG. 2 depicts a situation where it is desirable to hang adjacent pieces of art (or other objects) at the same height. In attempting to measure the height of a piece of art, it is often problematic or imprecise to estimate the true vertical direction in which to take the measurement. However, a typical wall provides numerous horizontal reference surfaces in the form of the ceiling, crown molding, chair rail and floor. The rectangular shape of the template body 11, and the width 21 and 23 of the edges 20 and 22, allows the use of these horizontal references to properly and consistently position the template in a vertical orientation.

As shown in FIG. 2, a wall surface is bounded at the upper edge by a ceiling 100 and further bounded by a crown molding 102 (or other generally horizontal surface). The template 10 can be positioned on the wall surface abutting the crown molding 102. The crown molding 102 provides a horizontal reference on which the upper edge 20 of template body 10 is registered. The perpendicular relation of the template upper edge 20 to the longitudinal axis 14, in combination with the known horizontal crown molding 102, ensures that the template now extends substantially vertically down the wall surface.

By reference to the template indicia 24, the template may be used to measure the vertical distance “Y” to the support 104 (e.g., a small nail, screw, or hook) of a pre-existing picture 106. The template is then repositioned on the wall surface, with the template upper edge 20 again abutting the crown molding 102, and used to measure to a new support location 110 for an additional picture 112. The location may be marked by placing a pencil or small nail directly through one of the template holes 12, or a point between adjacent template holes may be marked along the side of the template. In this manner, the vertical heights of the adjacent pictures are reliably matched. Of course, the template 10 may be used to hang the first picture 106.

It is often desirable to position a wall hanging on a wall some distance below and to one side of another wall hanging. This arrangement creates a visually appealing “stair-step” effect. As depicted in FIG. 3, the template 10 may be pinned or otherwise temporarily mounted on the wall surface through one of the upper holes 12 along the template longitudinal axis 14. The center of gravity of the template 10 may also lie along the longitudinal axis 14. The force of gravity acting on the template body 10 urges the template's longitudinal axis 14 into a substantially vertical orientation with the center of gravity lying directly below the point of support 120. In other words, the template 10 functions similar to a plumb bob to attain a true vertical orientation.

As further shown in FIG. 3, the point of support 120 of the template 10 may be the support of the selected uppermost piece of art 122. In other words, the uppermost piece of art may be removed from the wall, and its hanging nail (or other support) may be inserted through one of the holes 12 of the template 10. The template may then be used to take vertical measurements “Y” to achieve a consistent vertical spacing for the adjacent pieces of art 124 and 126. The template may also be used to aid in the horizontal positioning of the adjacent art 124 and 126. A right angle reference 128 is positioned on the template side 16 to provide a ready horizontal reference for measuring and marking the horizontal offset “X” to the final support locations 130 and 132 of the adjacent art. Alternatively, the template 10 can be swiveled about its temporary support 120, and a line marked to indicate the desired horizontal spacing. In any event, the adjacent pictures may now be positioned on the wall with a consistent vertical and horizontal spacing.

Additionally, the template 10 may be used to aid in determining the optimal horizontal position of an art piece on the wall. The template 10 can be held against the wall horizontally (by simply turning it sideways), then one of the ends can be abutted against a doorjamb, wall corner, etc., or it can be centered on the wall. A conventional carpentry level can be placed against one of the template edges 16, 18, 20, or 22 to permit the installer to orient the template in the true horizontal position. If needed, the installer can then slide the template horizontally to a position with one of the holes 12 at the approximate midpoint between two (or another number of) pre-existing objects or surfaces. This position can then be marked through the midpoint hole 12, as described above, to fix the support location for the art piece to be hung. Also, where an object to be hung needs two (or another number of) support locations, the installer can simply count the same number of holes 12 on opposite sides of the midpoint hole, and then mark these positions on the wall through these holes. And in another alternative aspect of the invention, the template can include a secondary body 15 similar to the template body 11 and pivotally coupled to it so that the secondary body can be pivoted into a horizontal position and slid along the length of the template body 11, for determining horizontal spacing for objects to be hung (see FIG. 7).

It will be understood that the template 10 can be used for more quickly, easily, and precisely hanging most any object on most any surface. For example, the template 10 can be used to hang drapes, blinds, mirrors, clocks, shelves, or other objects. In addition, the template can be used to hang such objects from a ceiling, from or on a windowsill, on a door, on a bookcase end, or on or from another surface. Also, the template 10 can be used to position an object upward relative to a baseboard or floor.

The invention thus aids in the positioning of wall-mounted articles. The template provides a consistent vertical reference on the wall surface either by abutting against adjacent surfaces, or by hanging from a support location in a vertical orientation. The template also provides a ready means for measuring distances along the template body and may be self-supporting on the wall surface. Horizontal measurements may also be accomplished more easily and accurately by reference to the vertical template.

While the invention has been disclosed in preferred forms, it will be apparent to those skilled in the art that many modifications, additions, and deletions may be made therein without departing from the spirit and scope of the invention as set forth in the following claims.

What is claimed is:

1. An apparatus for hanging pictures or other objects, the apparatus comprising:
an elongate template being substantially longer than it is wide, said elongate template having a central longitudinal axis, said elongate template further having a series of apertures formed therein extending therethrough from one side to another side thereof, said apertures being evenly spaced from one another and extending substantially along the length of said elongate template, said apertures being arranged linearly and positioned along said central longitudinal axis of said elongate template.

2. An apparatus as claimed in claim 1 further comprising visible indicia associated with each aperture.

3. An apparatus as claimed in claim 2 wherein said apertures are spaced one inch apart from one another.

4. An apparatus as claimed in claim 1 wherein a center of gravity of said elongate template lies along said central longitudinal axis.

5. An apparatus as claimed in claim 1 wherein said elongate template is substantially transparent.

6. An apparatus as claimed in claim 1 wherein said elongate template is substantially rectangular and substantially planar.

7. An apparatus as claimed in claim 1 wherein said apertures are sized to receive a pencil tip.

8. An apparatus as claimed in claim 1 wherein said apertures are sized to receive a small nail.

9. An apparatus for hanging pictures or other objects on a surface, said apparatus comprising:
an elongate template body being longer than it is wide and having a series of apertures formed therein extending substantially along the length of said elongate template body.

10. An apparatus as claimed in claim 9 wherein said template body has a center of gravity lying along an axis extending through said series of apertures.

11. An apparatus as claimed in claim 9 further comprising visible indicia associated with one or more of said apertures.

12. An apparatus as claimed in claim 9 further comprising visible indicia associated with each said aperture.

13. An apparatus as claimed in claim 9 wherein said apertures are spaced one inch apart.

14. An apparatus as claimed in claim 9 wherein said elongate template body is substantially transparent.

15. An apparatus as claimed in claim 9 where in said template body has upper and lower edges with widths that are sufficiently wide that, when abutted against the surface, permit said template longitudinal axis to define a direction perpendicular to the surface.

16. An apparatus as claimed in claim 15 wherein said template body has at least one enlarged head with a flat surface defining said upper or lower edge.

17. An apparatus as claimed in claim 10 wherein at least some of said apertures are defined off-center from said longitudinal axis.

18. An apparatus as claimed in claim 9 wherein said series of apertures comprises one slot along a substantial length of said template body.

19. An apparatus as claimed in claim 9 further comprising a second template body pivotally coupled to said first template body so that said secondary body may be pivoted and slid along the length of said template body.
